(19) United States
(12) Patent Application Publication
(10) Pub. No.: US 2005/0160113 A1
(43) Pub. Date: Jul. 21, 2005

(54) Time-based media navigation system

(75) Inventors: Michael James Sipusic, Singapore (SG); Xin Yan, Singapore (SG); Vivek Singh, Singapore (SG); Tommy Gunnar Nordqvist, Singapore (SG)

Correspondence Address: CONLEY ROSE, P.C., P. O. BOX 3267, HOUSTON, TX, 77253-3267, US

(73) Assignee: KENT RIDGE DIGITAL LABS, Singapore (SG)

(21) Appl. No.: 10/488,118

(22) PCT Filed: Aug. 31, 2001
(86) PCT No.: PCT/SG01/00174

(51) Int. Cl. G06F 17/00

(52) U.S. Cl. 707/104.1

(57) ABSTRACT

As system for navigating primary media and meta-data on a computer system is described. The system involves accessing primary media from a primary media source, and accessing meta-data from a meta-data source. The system also involves generating a graphical user interface (GUI) for providing interaction between a user and the system in relation to the primary media. The GUI includes means for facilitating control of the primary media currently being played, and means for displaying a multidimensional graphical representation for depicting a timeline for indicating the current location of the primary media being played relative to a reference location in the primary media, and providing information relating to the meta-data associated with the primary media at the current location.

### FIELD OF INVENTION

The invention relates generally to systems for media navigation. In particular, the invention relates to systems for navigating time-based media to which meta-data is linked.

### BACKGROUND

With the convergence of different types of media over digital networks, such as the Internet, new possibilities for interactive media are created. In the case of time-based media, such as digital video which is streamed over the Internet, it is possible to attach meta-data, for example viewer/reader/audience comments, to specific frames in the digital video. As this user-generated meta-data accumulates, navigational and display problems are created for future users. With access-time at a premium because of increasing traffic on the digital networks, users are likely to wish to sample both the digital video and annotations rather than view both exhaustively. Media navigation systems or media players with graphical user interfaces (GUI) are thus necessary for assisting users in making choices as to which comments to read and which segments of the digital video to watch.

An example of a conventional GUI-based device for navigating time-based media is Microsoft Corporation's Windows Media Player. The GUI concept of the Windows Media Player and other typical media players as shown in FIG. 1 is borrowed from video cassette recorder (VCR) control panels, whereby typical “tape transport” function buttons like play, stop, pause, fast-forward, and rewind buttons are used for viewing time-based media in a display window 102. As in the case of the VCR, these functions are represented by virtual buttons 104 which when “clicked” on using a mouse are turned on or off. Using these buttons, users may navigate through the progressive sequence of frames which comprise a time-based media file.

It is a common assumption that most time-based media are watched in a linear sequence, i.e. watched from the first frame till the last frame. Based on this assumption, media players are therefore designed to provide a timeline feature 106, the function of which is to display the location of the current displayed frame within the linear sequence of frames which make up the time-based media file. This is accomplished by providing a timeline 108 for representing the linear sequence of frames, and a current-location indicator 110, which slides along the timeline 108 as the time-based media is played, for indicating the relative position of the current displayed frame in relation to start and end points of the time-based media file. Besides representing the current position of the time-based media file, the current-location indicator 110 may also be manually manipulated to another location on the timeline 108. By doing so, the frame at the new indicator location to be displayed is selected. In this manner, a user may navigate through the time-based media file by estimating the duration of time-based media the user wishes to bypass, and converting which duration into the linear distance from the current-location indicator 110. Manually moving the current-location indicator 110 to the approximated location on the timeline 108 designates a new starting point for resuming the linear progression required for viewing the time-based media.

Currently, the timeline features of existing media players do not make provisions for displaying the location of prior user-derived meta-data created while the users interact with the media players. With media convergence rapidly becoming a reality, a new GUI concept is required to address the linkages between the primary time-based media and meta-data, including secondary text- or speech-based annotations.

Accordingly, there is a need for a system for navigating primary media and/or meta-data, and facilitating the generation and analysis of meta-data.

### SUMMARY

In accordance with a first aspect of the invention, a system for navigating primary media and meta-data on a computer system is described hereinafter. The system comprises means for accessing primary media from a primary media source, and means for accessing meta-data from a meta-data source. The system also comprises means for generating a graphical user interface (GUI) for providing interaction between a user and the system in relation to the primary media. The GUI includes means for facilitating control of the primary media currently being played, and means for displaying a multidimensional graphical representation for depicting a timeline for indicating the current location of the primary media being played relative to a reference location in the primary media, and providing information relating to the meta-data associated with the primary media at the current location.

In accordance with a second aspect of the invention, a method for navigating primary media and meta-data on a computer system is described hereinafter. The method comprises steps of accessing primary media from a primary media source, and accessing meta-data from a meta-data source. The method also comprises step of generating a graphical user interface (GUI) for providing interaction between a user and the method in relation to the primary media, including the steps of facilitating control of the primary media currently being played, and displaying a multidimensional graphical representation for depicting a timeline for indicating the current location of the primary media being played relative to a reference location in the primary media, and providing information relating to the meta-data associated with the primary media at the current location.

In accordance with a third aspect of the invention, a computer program product having a computer usable medium and computer readable program code means embodied in the medium for navigating primary media and meta-data on a computer system is described hereinafter. The product comprises computer readable program code means for causing the accessing of primary media from a primary media source, and computer readable program code means for causing the accessing of meta-data from a meta-data source. The product also comprises computer readable program code means for causing the generating of a graphical user interface (GUI) for providing interaction between a user and the method in relation to the primary media, including computer readable program code means for causing the facilitating of control of the primary media currently being played, and computer readable program code means for causing the displaying of a multidimensional graphical representation for depicting a timeline for indicating the current location of the primary media being played relative to a reference location in the primary media, and providing of information relating to the meta-data associated with the primary media at the current location.

### BRIEF DESCRIPTION OF DRAWINGS

Embodiments of the invention are described hereinafter with reference to the drawings, in which:

FIG. 1 shows the GUI of a conventional media player;

FIG. 2 shows the GUI of a media player with navigational tools for showing frequently or most viewed sequences in relation to a system according to embodiments of the invention;

FIG. 3 shows the GUI of another media player with navigational tools for providing information relating to meta-data which is linked to primary media in relation to a system according to embodiments of the invention;

FIG. 4a shows a block diagram of a media navigation and display system according to an embodiment of the invention;

FIG. 4b shows a block diagram of the Generator Module of FIG. 4a;

FIG. 5 is a flowchart showing the processes of data gathering in a session and repository updating after the session in relation to the User Behaviour Recording and Analysis Module of FIG. 4a;

FIG. 6 is a flowchart showing the processes of data gathering during each interaction and repository updating after each interaction in relation to the User Behaviour Recording and Analysis Module of FIG. 4a;

FIG. 7 is a flowchart showing the processes in relation to the Generator Module of FIG. 4a;

FIG. 8 is a flowchart showing the processes in relation to the Display Engine of FIG. 4a; and

FIG. 9 is a block diagram of a general-purpose computer for implementing the system of FIG. 4a.

### DETAILED DESCRIPTION

The foregoing need for a system which assists the user in navigating primary media and/or meta-data, through the generation and display of meta-data based on the history of user interaction with the system is addressed by embodiments of the invention described hereinafter.

Accordingly, a navigation and display system which uses prior user interactions as information to enable current users to make more efficient sampling decisions while browsing the progressively expanding contents of interactive media spaces according to an embodiment of the invention is described hereinafter. A number of GUI-based devices such as media players implemented for and based on the system are also described hereinafter.

In the description hereinafter, the following terns are used. A primary media consists of time-based media which is commented upon by people who are exposed to the primary media. Viewers, readers, or audiences of any time-based media which may include graphics, video, textual, or audio materials, are generally referred hereinafter as users. The history of user interaction with the primary media is considered meta-data about the primary media. Meta-data may be of two types. The first, in the form of written, spoken or graphical commentaries about the primary media constitutes a secondary media, which may be accessed along with the primary media. The second form of meta-data, consists of user actions that do not express an opinion; such as, the frequency of viewing a location in the primary media, or the attachment location were a comment is attached to a frame in the primary media. An interactive media space for a given time-based media includes a primary media and all the accumulated meta-data derived from user interactions with the system.

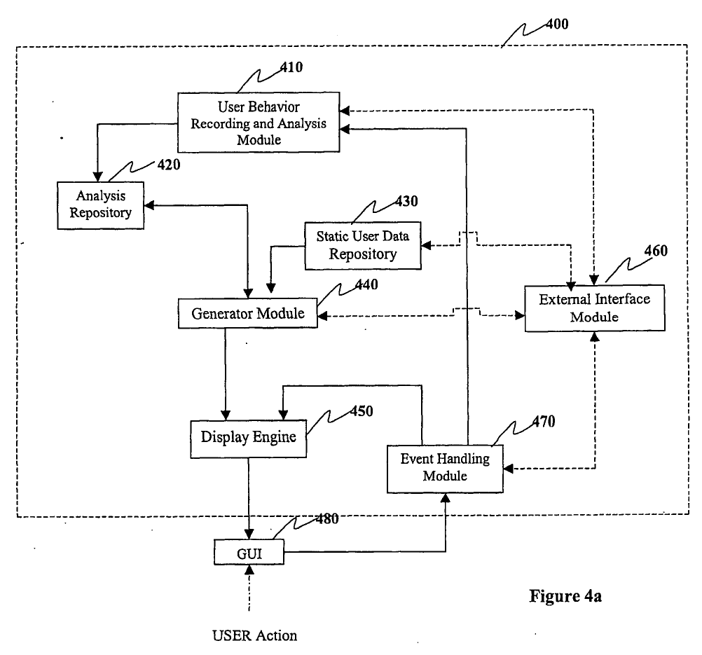

The system is capable of facilitating the process of locating data or frames of interest to the user in a time-based media. This feature facilitates the process of navigation by expanding the unidimensional timeline into a multidimensional graph structure. By converting the media time line into a variety of histograms, patterns of prior user interaction may be highlighted, which is described in further detail with reference to FIG. 3. These clusters of user activity may serve as navigational aides to future users of the system.

Such a system is cumulative, since the quality or effectiveness of the system improves with each user interaction. Information gathered during previous user interactions provides the basis for subsequent user interactions. Thus, each successive user interaction enriches the meta-data associated with the primary media.

The advantages of the system are manifold. In the field of interactive digital media, the system relates to user navigation of the linkages between a primary time-based media, such as video, and a secondary, user-created media, comprised of text or voice annotations, which is a form of meta-data, about the primary media. The system provides an improvement over the existing timeline features used in conventional media players by providing a mechanism for recording and displaying various dimensions of prior user behaviour, for each frame location within the primary media. By designating locational meta-data along the timeline, the traditional function of the timeline feature is expanded by highlighting the history of prior user interaction with the primary media. This meta-data serves as a navigational aid for users' content sampling decisions while viewing the primary media. The improved timeline feature is applicable to any time-based media such as video, computer-based animation, and audio materials.

A second advantage of this system concerns assisting the user in making content sampling decisions within the accumulating secondary media. Over time, the volume of user-created annotations will continue to grow, making it unlikely that current users will exhaustively cover the entire contents of the secondary media. Since some of the attached annotations may have inherent value equal to, or greater than, the primary media, it is important to provide users with meta-data to inform their navigational choices through the secondary media. Users may find accessing the meta-data by following the linear progression of the primary time-based media cumbersome. Therefore a problem arises as to how a user may decide which subset of the annotations to read within the secondary media.

The system addresses this problem by enabling prior user behaviour, as a form of meta-data, to be utilized by the GUI representation of the timeline feature to assist future users to make more intelligent choices as the users sample the interactive media space of primary media together with secondary media. The system marks user-derived meta-data for every frame location along the timeline of the media player. Because of the equal interval display duration of successive frames of time-based media, the system is able to treat existing timelines as the X-axis of a two dimensional graph. The Y-axis may then be used to represent the frequencies with which meta-data are attached at any given location within the time-based media file. For example, by converting the time-based media timeline feature into a histogram, patterns of prior user interaction may be highlighted. These clusters of user activity may then serve as navigational aids for subsequent users of the interactive media space. The system may be used with media players for dealing with user behaviour which is generated from viewing or using existing content and user behaviour which generates new content.

Media Players

A media player implemented for and based on the system is described hereinafter for displaying frequently or most viewed sequences along the timeline feature of the media player. By analysing user behaviour relating to each frame in a time-based media file, the system allows meta-data relating to the behaviour of users interacting with the system to be compiled. By subsequently making this information available to the current user, the system allows the user to navigate through the time-based media file by displaying the frequency with which other users accessed these segments. With this information, a user may then make a judgement whether to access a specific segment based on the frequency of prior users' viewing behaviour. The implementation of the media player is based on -the assumption that segments of high interest are accessed at a higher frequency than segments containing little interest or no relevance to the context in which the media file is accessed. The existing timeline of the timeline feature may be shown along as the X-axis of a two dimensional graph. The Y-axis may then be used to represent the frequencies in the form of a histogram. This is an example of an application of the system in which meta-data generated by the analysis of user behaviour by the system yields statistical data without any content.

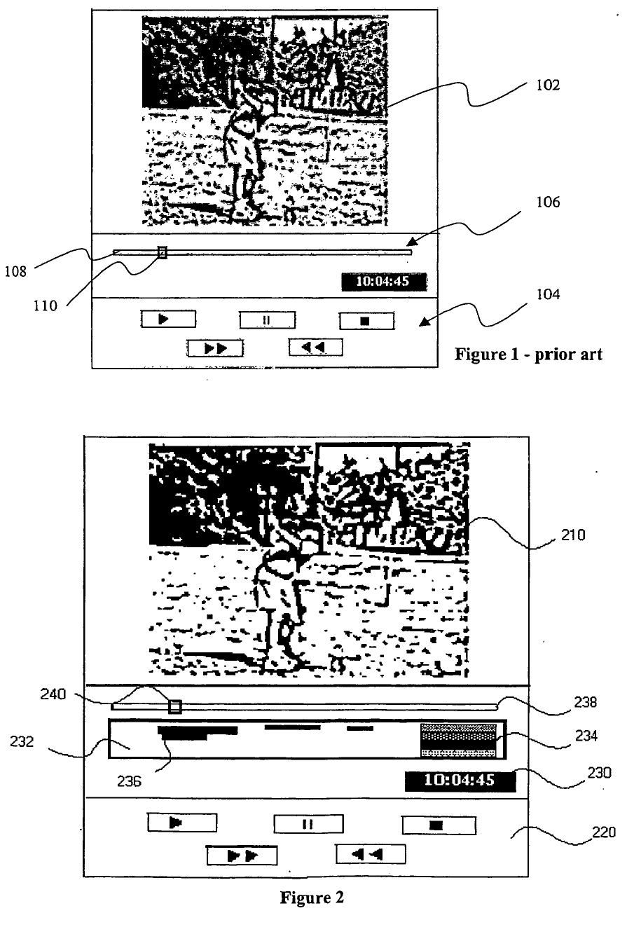

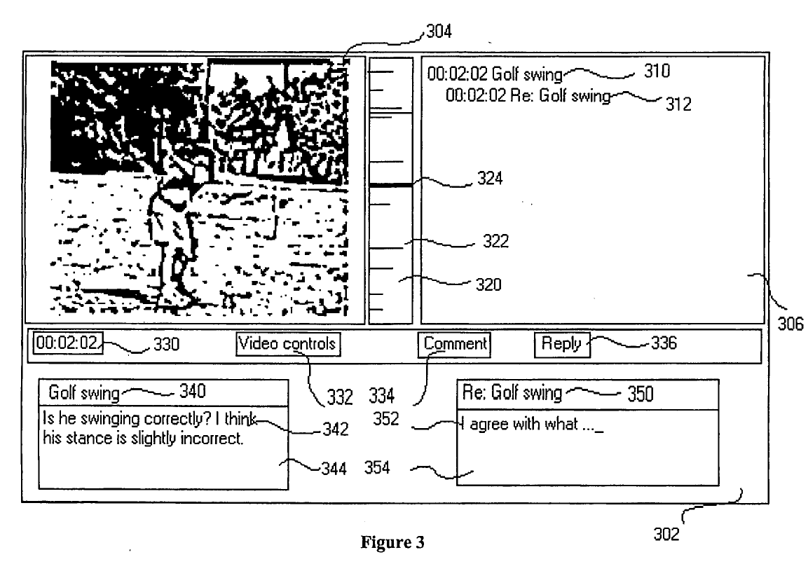

Such a media player is described in greater detail with reference to FIG. 2 for a time-based media such as video. In the media player a video display window 210 shows the time-based media currently in use, and is controlled by a set of video controls 220 for activating functions such as play, pause, fast-forward, stop and others. A time counter 230 indicates the relative location of the currently viewed frame in the hour:minutes:second or frame count format. A timeline navigator window 232 contains meta-data in relation to a timeline sweeper 240, which indicates the relative position of currently viewed frame to the rest of the sequence. The timeline sweeper 240 is attached to a timeline 238. Meta-data in the timeline navigator window 232 may be represented for example as single-dimensional data markers 236, the height of which indicates the frequency of viewings for a corresponding segment of the video sequence. With the timeline as a histogram, meta-data may also be represented in multidimensional form where markers contain additional information such as user profiles like user demographics. These multidimensional markers may be colour coded, symbol coded, pattern coded, or others. FIG. 1 shows one instance of multidimensional markers 234 with pattern coding, where each pattern corresponds to a specific profile such as age, and the overall height of the marker pattern indicates frequency of viewing for a corresponding segment of the video sequence.

In addition to displaying prior user viewing behaviour of the primary media, the histogram timeline may also be used to display the frequency of attachments of secondary media at each location along the timeline. A histogram plot may be created showing locations of annotations against a graduated timeline using the time stamp value assigned to the secondary media at its insertion point into the primary media. Special marks may be displayed along the timeline to identify the annotations, which have been viewed or created by other users. The implementation of the system displaying annotations which have been read by other users is based on the assumption that annotations of interest to prior users will be of interest to subsequent users. This is another example of an application of the system in which meta-data generated by analysing user behaviour by the system yields statistical data without any content.

In both the foregoing applications of the system, user behaviour analysis related to interacting with time-based media generates meta-data of statistical nature, but not secondary content or media. However, some user interactions or behaviour may also generate secondary content, for example, the process of creating annotation by a user for a time-based media. This type of interaction results in creation of meta-data having content and is thus a new media or secondary media. Such an action of creating secondary media may also be useful in deciding or pointing out sequences of interest in the primary media. A media player with a histogram plot implemented for and based on the system shows location and number of annotations against a graduated timeline relating to the primary time-based media. Cluster of annotations in the secondary media usually point to highly discussed sequences in the time-based media. Such an implementation points to “hotspots” in the time-based media via the timeline and histogram plot, thereby aiding the process of navigating through the time-based media. The histogram plot may be linked to the annotation trail, thus enabling a bi-directional navigation mechanism. Using this bi-directional navigation mechanism, the user can explore the annotations clustered tightly together at a hotspot and/or a sequence of frames in the primary media, thus providing a seamless navigational aid across the two medias. This is an example of an application of the system in which meta-data generated by analysing user behaviour has content.

Such a media player is described in greater detail with reference to FIG. 3. In the media player, the entire GUI 302 contains the various navigation modules which are used in the user behaviour-based navigation system. A media window 304 contains the video, audio, images or other time-based media which is currently in use. An annotation window 306 holds annotation submitted by users. Subject lines of main annotation threads 310 and replied annotations 312 are shown in the annotation window 306, in which the replied annotations 312 are indented for easier browsing. A timeline navigator window 320 contains data such as annotation locations 322 at which annotations have been attached to the time-based media. The annotation locations 322 also form a histogram plot from which information may be obtained regarding either the frequencies at which the annotations are read or number of annotations attached to the annotation locations. A timeline sweeper 324 indicates the currently viewed location of the time-based media file relative to the annotation locations 322. Where the timeline sweeper 324 coincides with a annotation location 322, the corresponding annotations attached to the time-based media at which frame are shown in the annotation window 306. A time counter 330 gives a time value stamp of currently viewed segment in the hour:minute:second format. A set of video controls 332 allows actuation of functions such as play, stop, fast-forward, rewind and other common functions. A comment button 334 allows a user to create a new annotation thread. Another reply button 336 allows a user to create a reply annotation in reply annotation box 354, which contains a reply annotation subject line 350 and a reply annotation message body 352. By accessing annotations in the annotation window 306 a user opens a annotation box 344, which contains a annotation subject line 340 and annotation message body 342.

The media window 304 may also display more than one time-based media. Situations which require the display of at least two time-based media include instances when two or more time-based media are being compared and annotations are created as a result of the comparison. Separate timeline navigator windows 320 are therefore required in these instances which relate to each time-base media for providing information relating to commentaries and replies associated with that time-based media. The annotations created during the comparison may be displayed in the annotation window 306.

System and System Components

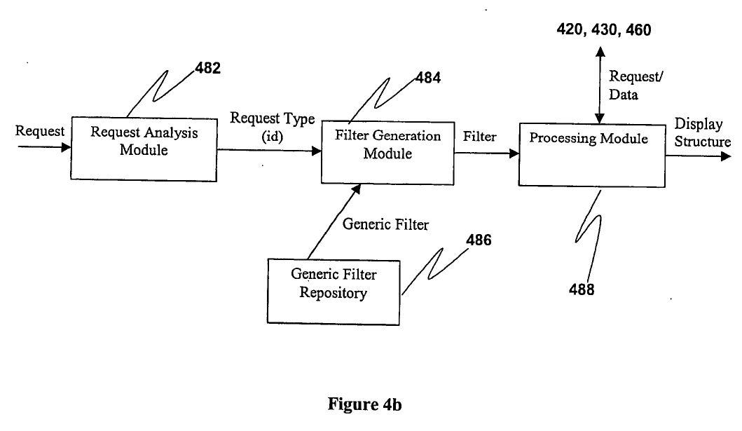

The system is described in greater detail hereinafter with reference to FIG. 4a. The system comprises a User Behaviour Recording and Analysis Module (UBRA) 410, Analysis Repository 420, Static User Data Repository 430, Generator Module 440, Display Engine Module 450, External Interface Module 460, and Event Handling Module 470. A user through a GUI module 480 communicates with the system for navigating primary media and meta-data and recording meta-data.

User Behaviour Recording and Analysis Module

A User Behaviour Recording Sub-module in the User Behaviour Recording and Analysis Module 410 is responsible for recording and analysing user behaviour which includes user's interaction with the system, such as adding annotation or annotation, reading or replying to annotations, rating annotations. User behaviour is recorded to gather data such as frames sequences viewed, number of annotations created or read from the Event Handling Module 470.

User behaviour may be recorded on a per interaction or per session basis, in which interaction based recordings account for each distinct interaction or action performed by the user on the system, while the session based recordings group all such interactions or actions in a user session.

An Analysis Sub-module is responsible for analysing the recorded data. Depending on the requirement this analysis is done for each user interaction or for all the interaction in a user session.

The analysis occurs on basis of time-based media accessed, and standard or custom algorithms or methodologies may be used for analysing user behaviour. An example is counting the number of annotations attached to a particular frame, for example represented in timecode, of video in a video-annotation system. Once analysed, the data generated is stored in the Analysis Repository 420.

For example, when a user creates a new annotation the event is recorded and during analysis the Analysis Repository (420) may be updated to reflect the same. The analysis may trigger updates in entries such as total number of annotations created by the user for the time-based media in use or accessed, time stamp in the time-based media where the annotation is created, and miscellaneous data such as time elapsed from last creation or update.

Analysis Repository

The Analysis Repository 420 stores the analysed data generated by the User Behaviour Recording and Analysis Module 410. The Analysis Repository 420 stores dynamic data, which is data which changes with each user interaction.

The Analysis Repository 420 may store the data based on the user or time-based media, or a combination of the two. Depending on the scale of the implementation and complexity of the system, one of the strategies may be adopted.

Data pertaining to most frequently viewed sequences or number of annotations is preferably stored with reference to the time-based media of interest, while data such as viewing habits of a user, annotation viewed or read by a user are preferably stored with reference to the user. In most circumstances a combination of the two is required.

Static User Data Repository

The Static User Data Repository 430 stores static data such as data related to user profile like gender, age, interests and others. This type of data is obtained from an external source through the External Interface Module 460.

Generator Module

The Generator Module 440 is responsible for processing the data stored in the Analysis Repository 420 and Static User Data Repository 430 so as to obtain data which may serve as a navigational tool. The processing is done based on rules or criteria which may be defined by the system or the user. The rules and criteria may be used to form entities like filters, which may be used to gather relevant data for processing. The processed data is packaged into a data structure and sent to the Display Engine 450 for further processing.

An example of an operation is when a user wishes to navigate the time-based media as viewed by a demographic population of age 19-28. A filter may be created which gathers user identification (ID) of users within the age group of 19-28 from the Static User Data Repository 430. These user IDs are used to form another filter to gather data from the Analysis Repository 420 for the time-based media of interest. Assuming the Analysis Repository 420 stores data for each user for each time-based media viewed or accessed, such an operation is easily accomplished. After gathering relevant data, conventional statistical operations may be used to obtain a trend. This information is then packaged and sent to the Display Engine 450.

The Generator Module 440 is described in greater detail with reference to FIG. 4b. The Generator Module 440 includes a Request Analysis Module 482, Filter Generation Module 484, Generic Filter Repository 486, and Processing Module 488. The Generator Module 440 receives a request for displaying the navigational tool, which may be generated by the user coming from the Event Handling Module 470 or due to a predetermined state set by the user or defined by the system. The request defines the type of information to be displayed with the timeline feature. For example, a request may be made for displaying frequently viewed sequences, or annotation frequency distribution in the time-based media. The request is obtained and the respective type thereof identified in the Request Analysis Module 482. Depending on the request, appropriate rules or criteria are formulated in the Filter Generation Module 484. The rules or criteria may be embodied as filters in the Generator Module 440. These filters may be generic, like filters for obtaining the annotation distribution for a video footage, or customized, like filters for obtaining the annotation distribution for a video footage satisfying the condition which the creator of the annotation be in the age group of 18-30 years. The generic filters are obtained from the Generic Filter Repository 486. Once the filters are formulated, the data is obtained from the Analysis Repository 420 and/or Static User Data Repository 430. Required data may also be obtained from external entities through the External Interface Module 460. Filters are applied and a data structure generated in the Processing Module 488 for the Display Engine Module 450. Filters may also be used directly when obtaining the data from the repositories 420 or 430. A simple implementation of filters may consist of statements which query the database implementing the Analysis Repository 420 and/or Static User Data Repository 430.

Display Engine

The Display Engine Module 450 is responsible for obtaining the data to be displayed as a data structure from the Generator Module 440. Depending on the visualization characteristics as specified in the implementation of the system or by the user, the Display Engine 450 then generates a visual component or object. The GUI or visualization object generated by the Display Engine Module 450 may be deployed as a plug-in for an existing media player or GUI module 480 superimposing the original timeline of the media player, deployed as a plug-in for the existing media players providing an additional timeline, or deployed as a separate standalone visual entity which works in synchronisation with the existing media player.

External Interface Module

The External Interface Module 460 is responsible for providing an interface between any external entities and the modules in the system. The interactions with the external entities may be requests for data, updating of data for external entities, or propagating events. For example in a video annotation system, the system is required receive a video from a video database and the associated annotations from an annotation database. During any interactive session with users, the system may need to update the annotation database with the actual contents of the new annotation created during these sessions.

Event Handling Module

The Event Handling Module 470 is responsible for handling events triggered by user interactions with the system through the media player or GUI module 480. Such events may be internal or external in nature. Internal events are handled by the system, while external events are propagated to external entities via the External Interface Module 460.

Process Flows in the System

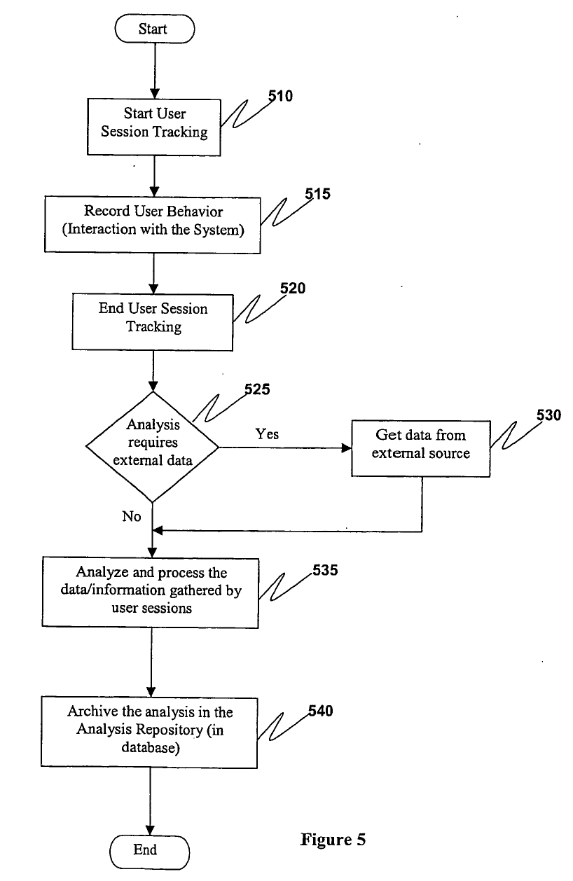

A number of process flows in the system are described hereinafter with reference to flowcharts shown in FIGS. 5 to 8.

The flowchart shown in FIG. 5 relates to processes of data gathering in a session and repository updating after the session in the User Behaviour Recording and Analysis Module 410. The user behaviour tracking or recording process 515 starts in a step 510 when a user logs into the system and starts a session. The user behaviour tracking or recording ends in a step 520 when the user ends the session. The analysis starts after the session tracking finishes. If the analysis requires external data as determined in a step 525, a request is sent and data received in a step 530 via the External Interface Module 460. The data gathered is processed or analysed in a step 535 based on the standard or custom algorithms implemented in the system. The results generated by the analysis process are sent to the Analysis Repository 420 for storage or update in a step 540.

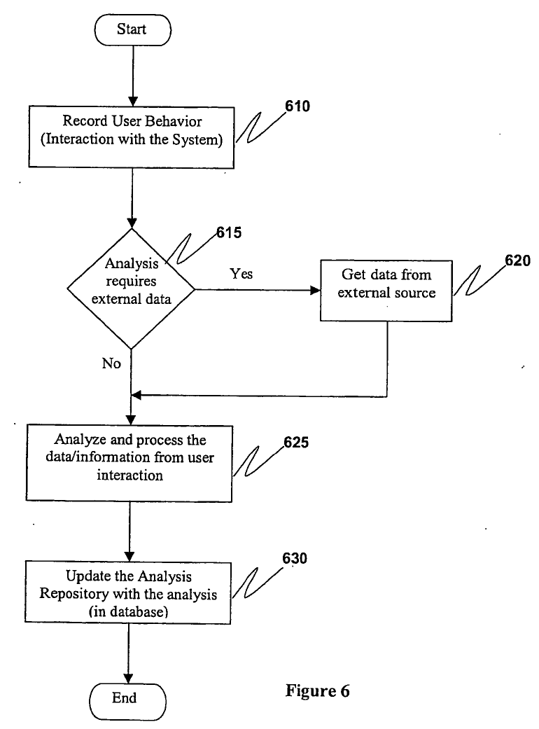

The flowchart shown in FIG. 6 relates to processes of data gathering during each interaction and repository updating after each interaction in the User Behaviour Recording and Analysis Module 410. Each user behaviour or user interaction with the system is tracked or recorded in a process 610. If the analysis requires external data as determined in a step 615, a request is sent and data received in a step 620 via the External Interface Module 460. The data gathered is processed or analysed in a step 625 based on the standard or custom algorithms implemented in the system. The results generated by the analysis process are sent to the Analysis Repository 420 for storage or update in a step 630.

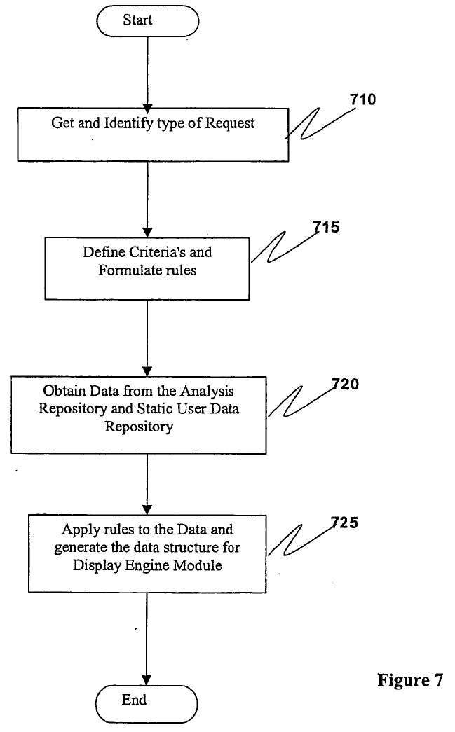

The flowchart shown in FIG. 7 relates to processes in the Generator Module 440. The Generator Module 440 receives a request for displaying the navigational tool, and the request is then analysed and identified for type in a step 710. Depending on the request, appropriate rules or criteria are formulated in a step 715. Once the filters have been formulated, the data is obtained from the Analysis Repository 420 and/or Static User Data Repository 430, and/or external entity in a step 720. Filters are applied and a data structure generated for the Display Engine Module 450 in a step 725.

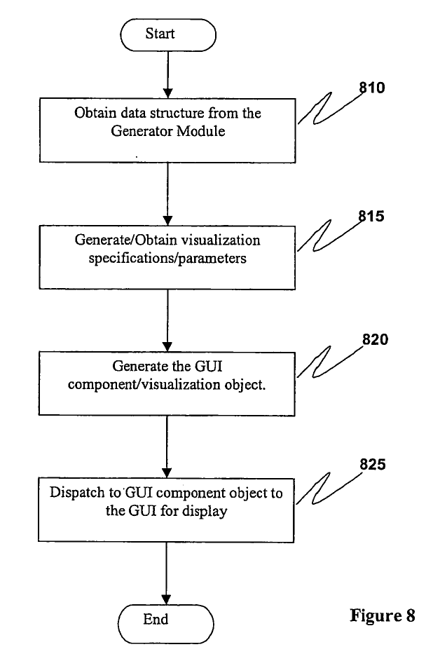

The flowchart shown in FIG. 8 relates to processes in the Display Engine Module 450. On obtaining the display data structure from the Generator Module 440 in a step 810, the Display Engine Module 450 generates or obtains the visualization parameters in a step 815. These parameters contain information like size of displayed object, color scheme for the display and others. These parameters are user or system defined. The GUI component to be displayed is then generated in a step 820 based on the data or parameters obtained in the previous steps. The GUI or visualization object hence generated is sent to the GUI module 480 for display in a step 825.

Computer Implementation

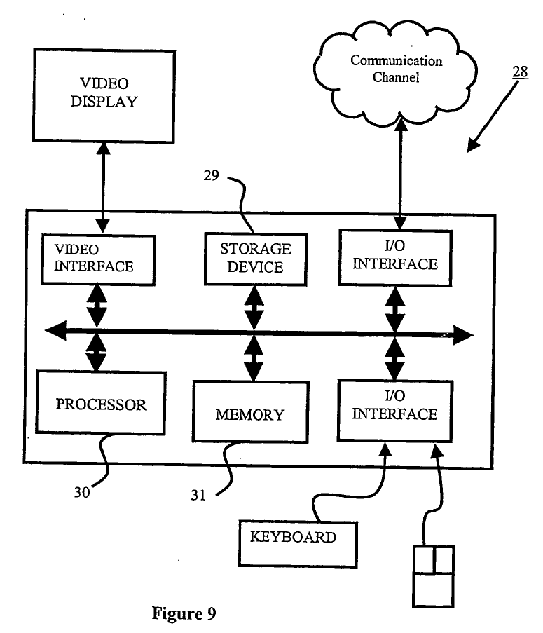

The embodiments of the invention are preferably implemented using a computer, such as the general-purpose computer shown in FIG. 9, or group of computers that are interconnected via a network. In particular, the functionality or processing of the navigation system of FIG. 4 may be implemented as software, or a computer program, executing on the computer or group of computers. The method or process steps for providing the navigation system are effected by instructions in the software that are carried out by the computer or group of computers in a network. The software may be implemented as one or more modules for implementing the process steps. A module is a part of a computer program that usually performs a particular function or related functions. Also, a module can also be a packaged functional hardware unit for use with other components or modules.

In particular, the software may be stored in a computer readable medium, including the storage devices described below. The software is preferably loaded into the computer or group of computers from the computer readable medium and then carried out by the computer or group of computers. A computer program product includes a computer readable medium having such software or a computer program recorded on it that can be carried out by a computer. The use of the computer program product in the computer or group of computers preferably effects the navigation system in accordance with the embodiments of the invention.

The system 28 is simply provided for illustrative purposes and other configurations can be employed without departing from the scope and spirit of the invention. Computers with which the embodiment can be practiced include IBM-PC/ATs or compatibles, one of the Macintosh (TM) family of PCs, Sun Sparcstation (TM), a workstation or the like. The foregoing is merely exemplary of the types of computers with which the embodiments of the invention may be practiced. Typically, the processes of the embodiments, described hereinafter, are resident as software or a program recorded on a hard disk drive (generally depicted as block 29 in FIG. 9) as the computer readable medium, and read and controlled using the processor 30. Intermediate storage of the program and any data may be accomplished using the semiconductor memory 31, possibly in concert with the hard disk drive 29.

In some instances, the program may be supplied to the user encoded on a CD-ROM or a floppy disk (both generally depicted by block 29), or alternatively could be read by the user from the network via a modem device connected to the computer, for example. Still further, the software can also be loaded into the computer system 28 from other computer readable medium including magnetic tape, a ROM or integrated circuit, a magneto-optical disk, a radio or infra-red transmission channel between a computer and another device, a computer readable card such as a PCMCIA card, and the Internet and Intranets including email transmissions and information recorded on websites and the like. The foregoing is merely exemplary of relevant computer readable mediums. Other computer readable mediums may be practiced without departing from the scope and spirit of the invention.

In the foregoing manner, a system for navigating primary media and/or meta-data, and facilitating the generation and analysis of meta-data is described. Although only a number of embodiments of the invention are disclosed, it may become apparent to one skilled in the art in view of this disclosure that numerous changes and/or modification may be made without departing from the scope and spirit of the invention.

1. A system for navigating primary media and meta-data on a computer system, comprising
means for accessing primary media from a primary media source;
means for accessing meta-data from a meta-data source; and
means for generating a graphical user interface (GUI) for providing interaction between a user and the system in relation to the primary media, the GUI including
means for facilitating control of the primary media currently being played, and
means for displaying a multidimensional graphical representation for depicting a timeline for indicating the current location of the primary media being played relative to a reference location in the primary media, and providing information relating to the meta-data associated with the primary media at the current location.

2. The system as in claim 1, wherein the means for displaying the multidimensional graphical representation includes means for providing as information relating to the meta-data, information relating to the history of user interaction.

3. The system as in claim 2, wherein the means for displaying the multidimensional graphical representation includes means for providing as information relating to the meta-data, information relating to the history of user interaction at each location of the primary media.

4. The system as in claim 2, wherein the means for displaying the multidimensional graphical representation includes means for providing as information relating to the history of user interaction, information relating to the frequency with which the primary media is played at the current location.

5. The system as in claim 2, wherein the means for displaying the multidimensional graphical representation includes means for providing as information relating to the history of user interaction, information relating to the number of annotations associated with the primary media at the current location.

6. The system as in claim 2, wherein the means for displaying the multidimensional graphical representation includes means for providing as information relating to the history of user interaction, information relating to the frequency of annotations associated with the primary media at the current location that are read.

7. The system as in claim 1, wherein the means for facilitating control of the primary media currently being played includes means for facilitating control of the meta-data.

8. The system as in claim 1, wherein the means for accessing meta-data from a meta-data source includes means for accessing secondary media from a secondary media source.

9. The system as in claim 1, wherein the means for generating the GUI includes means for displaying annotations associated with the primary media.

10. The system as in claim 9, wherein the means for displaying annotations includes means for displaying annotation threads.

11. The system as in claim 10, wherein the means for displaying annotation threads includes means for retrieving commentaries associated with the primary media.

12. The system as in claim 11, wherein the means for displaying annotation threads further includes means for retrieving replies to commentaries associated with the primary media.

13. The system as in claim 12, wherein the means for displaying annotations further includes means for inputting annotations.

14. The system as in claim 1, wherein the means for generating the GUI includes means for generating display instructions on a user computer through which the user interacts with the system and means for accepting input from the user through the user computer.

15. The system as in claim 1, further including means for recording user behaviour and analysing the recorded user behaviour.

16. The system as in claim 15, wherein the means for recording and analysing includes means for recording user behaviour wherein user behaviour is recorded based on input received through the means for accepting input from the user.

17. The system as in claim 16, wherein the means for recording and analysing includes means for analysing the recorded user behaviour.

18. The system as in claim 17, wherein the means for analysing user behaviour is based on each interaction between the user and the system.

19. The system as in claim 17, wherein the means for analysing user behaviour is based on each session of interactions between the user and the system.

20. The system as in claim 16, further including means for storing information relating to analysed user behaviour resulting from means for analysing the recorded user behaviour.

21. The system as in claim 20, further including means for generating navigational information based on information relating to analysed user behaviour.

22. The system as in claim 21, wherein means for generating navigational information is based on the use of rules and criteria for generating navigational information.

23. The system as in claim 22, wherein means for generating navigational information is based on the use of filters.

24. The system as in claim 21, further including means for interfacing for facilitating communication between the system and any external data source.

25. A method for navigating primary media and meta-data on a computer system, comprising steps of:
accessing primary media from a primary media source;
accessing meta-data from a meta-data source; and
generating a graphical user interface (GUI) for providing interaction between a user and the method in relation to the primary media, including the steps of
facilitating control of the primary media currently being played, and
displaying a multidimensional graphical representation for depicting a timeline for indicating the current location of the primary media being played relative to a reference location in the primary media, and providing information relating to the meta-data associated with the primary media at the current location.

26. The method as in claim 25, wherein the step of displaying the multidimensional graphical representation includes step of providing as information relating to the meta-data, information relating to the history of user interaction.

27. The method as in claim 26, wherein the step of displaying the multidimensional graphical representation includes step of providing as information relating to the meta-data, information relating to the history of user interaction at each location of the primary media.

28. The method as in claim 26, wherein the step of displaying the multidimensional graphical representation includes step of providing as information relating to the history of user interaction, information relating to the frequency with which the primary media is played at the current location.

29. The method as in claim 26, wherein the step of displaying the multidimensional graphical representation includes step of providing as information relating to the history of user interaction, information relating to the number of annotations associated with the primary media at the current location.

30. The method as in claim 26, wherein the step of displaying the multidimensional graphical representation includes step of providing as information relating to the history of user interaction, information relating to the frequency of annotations associated with the primary media at the current location that are read.

31. The method as in claim 25, wherein the step of facilitating control of the primary media currently being played includes step of facilitating control of the meta-data.

32. The method as in claim 25, wherein the step of accessing meta-data from a meta-data source includes step of accessing secondary media from a secondary media source.

33. The method as in claim 25, wherein the step of generating the GUI includes step of displaying annotations associated,with the primary media.

34. The method as in claim 33, wherein the step of displaying annotations includes step of displaying annotation threads.

35. The method as in claim 34, wherein the step of displaying annotation threads includes step of retrieving commentaries associated with the primary media.

36. The method as in claim 35, wherein the step of displaying annotation threads further includes step of retrieving replies to commentaries associated with the primary media.

37. The method as in claim 36, wherein the step of displaying annotations further includes step of inputting annotations.

38. The method as in claim 25, wherein the step of generating the GUI includes step of generating display instructions on a user computer through which the user interacts with the computer system and step of accepting input from the user through the user computer.

39. The method as in claim 25, further including step of recording user behaviour and analysing the recorded user behaviour.

40. The method as in claim 39, wherein the step of recording and analysing includes step of recording user behaviour wherein user behaviour is recorded based on input received through accepting input from the user.

41. The method as in claim 40, wherein the step of recording and analysing includes step of analysing the recorded user behaviour.

42. The method as in claim 41, wherein the step of analysing user behaviour is based on each user interaction.

43. The method as in claim 41, wherein the step of analysing user behaviour is based on each session of user interactions.

44. The method as in claim 40, further including step of storing information relating to analysed user behaviour resulting from analysing the recorded user behaviour.

45. The method as in claim 44, further including step of generating navigational information based on information relating to analysed user behaviour.

46. The method as in claim 45, wherein step of generating navigational information is based on the use of rules and criteria for generating navigational information.

47. The method as in claim 46, wherein step of generating navigational information is based on the use of filters.

48. The method as in claim 45, further including step of facilitating communication between the computer system and any external data source.

49. A computer program product having a computer usable medium and computer readable program code means embodied in the medium for navigating primary media and meta-data on a computer system, the product comprising:
computer readable program code means for causing the accessing of primary media from a primary media source;
computer readable program code means for causing the accessing of meta-data from a meta-data source; and
computer readable program code means for causing the generating of a graphical user interface (GUI) for providing interaction between a user and the method in relation to the primary media, including
computer readable program code means for causing the facilitating of control of the primary media currently being played, and
computer readable program code means for causing the displaying of a multidimensional graphical representation for depicting a timeline for indicating the current location of the primary media being played relative to a reference location in the primary media, and providing of information relating to the meta-data associated with the primary media at the current location.

50. The product as in claim 49, wherein the computer readable program code means for causing the displaying of the multidimensional graphical representation includes computer readable program code means for causing the providing as information relating to the meta-data, of information relating to the history of user interaction.

51. The product as in claim 50, wherein the computer readable program code means for causing the displaying of the multidimensional graphical representation includes computer readable program code means for causing the providing as information relating to the meta-data, of information relating to the history of user interaction at each location of the primary media.

52. The product as in claim 50, wherein the computer readable program code means for causing the displaying of the multidimensional graphical representation includes computer readable program code means for causing the providing as information relating to the history of user interaction, of information relating to the frequency with which the primary media is played at the current location.

53. The product as in claim 50, wherein the computer readable program code means for causing the displaying of the multidimensional graphical representation includes computer readable program code means for causing the providing as information relating to the history of user interaction, of information relating to the number of annotations associated with the primary media at the current location.

54. The product as in claim 50, wherein the computer readable program code means for causing the displaying of the multidimensional graphical representation includes computer readable program code means for causing the providing as information relating to the history of user interaction, of information relating to the frequency of annotations associated with the primary media at the current location that are read.

55. The product as in claim 49, wherein the computer readable program code means for causing the facilitating of control of the primary media currently being played includes computer readable program code means for causing the facilitating of control of the meta-data.

56. The product as in claim 49, wherein the computer readable program code means for causing the accessing of meta-data from a meta-data source includes computer readable program code means for causing the accessing of secondary media from a secondary media source.

57. The product as in claim 49, wherein the computer readable program code means for causing the generating of the GUI includes computer readable program code means for causing the displaying of annotations associated with the primary media.

58. The product as in claim 57, wherein the computer readable program code means for causing the displaying of annotations includes computer readable program code means for causing the displaying of annotation threads.

59. The product as in claim 58, wherein the computer readable program code means for causing the displaying of annotation threads includes computer readable program code means for causing the retrieving of commentaries associated with the primary media.

60. The product as in claim 59, wherein the computer readable program code means for causing the displaying of annotation threads further includes computer readable program code means for causing the retrieving of replies to commentaries associated with the primary media.

61. The product as in claim 60, wherein the computer readable program code means for causing the displaying annotations further includes computer readable program code means for causing the inputting of annotations.

62. The product as in claim 49, wherein the computer readable program code means for causing the generating of the GUI includes computer readable program code means for causing the generating of display instructions on a user computer through which the user interacts with the computer system and computer readable program code means for causing the accepting of input from the user through the user computer.

63. The product as in claim 49, further including computer readable program code means for causing the recording of user behaviour and analysing of the recorded user behaviour.

64. The product as in claim 63, wherein the computer readable program code means for causing the recording and analysing includes computer readable program code means for causing the recording of user behaviour wherein user behaviour is recorded based on input received through causing the accepting of input from the user.

65. The product as in claim 64, wherein the computer readable program code means for causing the recording and analysing includes computer readable program code means for causing the analysing of the recorded user behaviour.

66. The product as in claim 65, wherein the computer readable program code means for causing the analysing of user behaviour is based on each user interaction.

67. The product as in claim 65, wherein the computer readable program code means for causing the analysing of user behaviour is based on each session of user interactions.

68. The product as in claim 64, further including computer readable program code means for causing the storing of information relating to analysed user behaviour resulting from causing the analysing of the recorded user behaviour.

69. The product as in claim 68, further including computer readable program code means for causing the generating of navigational information based on information relating to analysed user behaviour.

70. The product as in claim 69, wherein computer readable program code means for causing the generating of navigational information is based on the use of rules and criteria for generating navigational information.

71. The product as in claim 70, wherein computer readable program code means for causing the generating of navigational information is based on the use of filters.

72. The product as in claim 69, further including computer readable program code means for causing the facilitating of communication between the computer system and any external data source.
